(19) United States
(12) Patent Application Publication
(10) Pub. No.: US 2026/0332251 A1
(43) Pub. Date: Oct. 22, 2026

(54) DEVICES INCLUDING BACKSCATTER MODULATORS AND FILTERS, AND SELECTIVE BACKSCATTER MODULATION TECHNIQUES

(71) Applicant: University of Washington, Seattle, WA (US)

(72) Inventors: Matthew S. Reynolds, Edmonds, WA (US); Kevin Ho, Seattle, WA (US)

(21) Appl. No.: 19/649,644

(22) Filed: Apr. 16, 2026

Related U.S. Application Data
(60) Provisional application No. 63/790,611, filed on Apr. 17, 2025.

(51) Int. Cl. H04B 7/22; H04W 76/15

(52) U.S. Cl. CPC H04B 7/22; H04W 76/15

(57) ABSTRACT

Examples of devices including backscatter modulators include at least one antenna configured to receive an incident signal, a backscatter modulator configured to switch between impedances in accordance with transmit data to provide a switched impedance, and a filter coupled to the backscatter modulator. The filter filters the incident signal to provide a filtered incident signal to the backscatter modulator and filters a reflected signal from the switched impedance to provide a filtered reflected signal to the at least one antenna. The filter may pass frequencies within a particular Bluetooth, Wi-Fi, or cellular communication channel while attenuating frequencies outside the channel, thereby reducing spectrum pollution in some examples by reducing modulation of out-of-channel incident signals.

### CROSS-REFERENCE TO RELATED APPLICATIONS

This application claims the benefit under 35 U.S.C. § 119 of the earlier filing date of U.S. Provisional Application Ser. No. 63/790,611 filed Apr. 17, 2025, the entire contents of which are hereby incorporated by reference in their entirety for any purpose.

### TECHNICAL FIELD

Examples described herein generally relate to wireless communication devices and techniques for wireless systems including backscatter communication. Examples of backscatter modulators including filters for frequency selective backscatter operation are described.

### BACKGROUND

Backscatter communication allows wireless devices to transmit data by modulating reflected radio frequency signals, rather than generating their own carrier waves. This approach can dramatically reduce power consumption in wireless Internet of Things (IoT) sensors and other low-power devices. In a backscatter system, an external carrier source provides the radio frequency energy, and a backscatter device modulates its antenna impedance to re-radiate a modulated signal that can be received by other devices within range. A backscatter modulator employing a binary modulation scheme presents at least two switchable impedances to an antenna, which may be realized with a diode or transistor RF switch.

Backscatter modulators may backscatter energy from a desired carrier source, but they may also backscatter energy from other nearby sources present in the environment. This can lead to spectrum pollution that may interfere with other nearby communication links. For example, in environments with Wi-Fi, Bluetooth, and/or cellular communication signals, conventional backscatter modulators may modulate all incident signals within the bandwidth of the antenna, regardless of whether those signals correspond to a desired communication channel. This unintended modulation of out-of-band or out-of-channel signals can contribute to interference with existing wireless communications.

### BRIEF DESCRIPTION OF THE DRAWINGS

FIG. 1 is a schematic illustration of a wireless device incorporating a frequency selective backscatter modulator arranged in accordance with examples described herein.

FIG. 2 is a block diagram of a wireless device incorporating a frequency selective backscatter modulator arranged in accordance with examples described herein.

FIG. 3 is a schematic illustration of an apparatus including a frequency selective backscatter modulator arranged in accordance with examples described herein.

FIG. 4 is a comparative diagram illustrating a backscatter modulator and a frequency-selective backscatter modulator with corresponding spectra.

FIG. 5A is a schematic diagram of a frequency selective backscatter modulator using a splitter and respective filters and switches for first and second channels, arranged in accordance with examples described herein.

FIG. 5B is a schematic diagram of a frequency selective backscatter modulator using a quadrature hybrid coupler and respective filters and switches for first and second channels, arranged in accordance with examples described herein.

FIG. 5C is a schematic diagram of a frequency selective backscatter modulator using an antenna-side switch and respective filters and switches for first and second channels, arranged in accordance with examples described herein.

FIG. 6 is a flow chart illustrating a method for backscattering, arranged in accordance with examples described herein.

FIG. 7 is a flow chart illustrating a method for communicating on a particular Bluetooth or Wi-Fi communication channel, arranged in accordance with examples described herein.

### DETAILED DESCRIPTION

Certain details are set forth herein to provide an understanding of described embodiments of technology. However, other examples may be practiced without various of these particular details. In some instances, well-known circuits, control signals, timing protocols, communication components, wireless protocol specifics, and/or software operations have not been shown in detail in order to avoid unnecessarily obscuring the described embodiments. Other embodiments may be utilized, and other changes may be made, without departing from the spirit or scope of the subject matter and/or claims presented here.

Examples of devices including frequency selective backscatter modulators include at least one antenna configured to receive an incident signal, a backscatter modulator configured to switch between impedances in accordance with transmit data to provide a switched impedance, and a filter coupled to the backscatter modulator. The filter filters the incident signal to provide a filtered incident signal to the backscatter modulator and filters a reflected signal from the switched impedance to provide a filtered reflected signal to the at least one antenna. The filter may pass frequencies within a particular Bluetooth, Wi-Fi, or cellular communication channel while attenuating frequencies outside the channel, thereby reducing spectrum pollution in some examples by reducing modulation of out-of-channel incident signals.

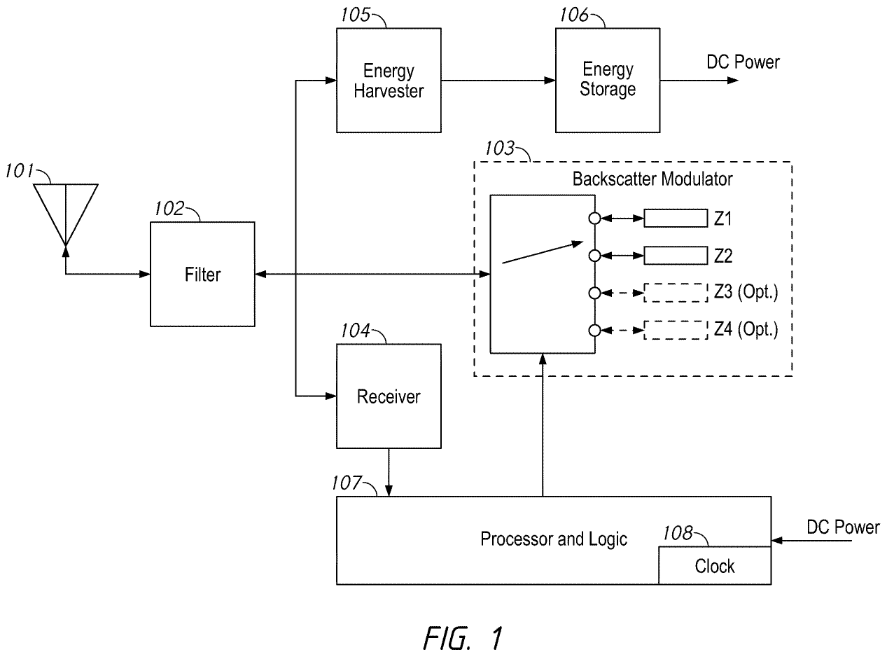

FIG. 1 is a schematic illustration of a wireless device incorporating a frequency selective backscatter modulator arranged in accordance with examples described herein. The wireless device includes an antenna 101 coupled to a filter 102. The filter 102 is coupled to a backscatter modulator 103, a receiver 104, and an energy harvester 105. The energy harvester 105 is coupled to energy storage 106. The backscatter modulator 103, the receiver 104, and the energy storage 106 are each coupled to logic 107. A clock 108 is coupled to the logic 107. DC power may be provided to the logic 107. DC power may include sources such as a primary battery, a rechargeable battery, a printed battery, a capacitor or supercapacitor, a radio frequency energy harvester, a solar cell, or other sources of stored and/or harvested energy.

The example in FIG. 1 is exemplary. Additional, fewer, and/or different components may be provided in other examples.

Examples of devices described herein may include one or more antennas, such as antenna 101 of FIG. 1. The antenna 101 is coupled to one port of the filter 102 and may receive incident signals from an environment, such as radio frequency signals. In some examples, the antenna 101 may be implemented using a monopole whip antenna, a dipole antenna, a patch antenna, and/or an inverted-F antenna for transmitting and receiving signals in a desired frequency range. Examples of the antenna 101 may operate within the industrial, scientific, and medical (ISM) bands, such as 902-928 MHz, 2.4-2.483 GHz, or 5.725-5.850 GHz. In examples where the wireless device operates with Bluetooth or Wi-Fi protocols, the antenna 101 may have a passband to cover the 2.4 GHz, 5 GHz and/or 6 GHz frequency range. In examples where the wireless device operates using cellular protocols such as the 3GPP Release 19 or other versions, the antenna 101 may have a passband corresponding to cellular bands such as the fifth generation new radio (5G-NR) bands.

Examples of devices described herein may include one or more filters, such as filter 102 of FIG. 1. The filter 102 is coupled between the antenna 101 and other circuit elements, including the backscatter modulator 103, the receiver 104, and the energy harvester 105. The filter 102 has a passband that corresponds to a particular frequency band, e.g., a single desired channel, or a subset of desired channels. In some examples, the filter 102 may be implemented using an inductor-capacitor filter, a microstrip filter, a low-temperature cofired ceramic (LTCC) filter, a surface acoustic wave (SAW) filter, or a bulk acoustic wave (BAW) filter. The passband of the filter 102 may in some examples include an entire ISM band used by RFID, Wi-Fi (IEEE 802.11), or Bluetooth devices. In some examples, the passband of the filter may in some examples include one or more 5G-NR bands or specific channels therein. In some examples, the passband may be specific to a particular channel or subset of channels within such frequency bands. For instance, the filter 102 may have a passband corresponding to Wi-Fi channel 1 (2401-2423 MHz), Wi-Fi channel 11 (2451-2473 MHz), or Bluetooth channel 37 (2.401-2.403 GHz). The filter 102 may perform two filtering functions in examples described herein. First, the filter 102 may filter incident signals from the antenna 101 to provide filtered incident signals to the backscatter modulator 103. Also, the filter 102 may filter reflected signals from the backscatter modulator 103 to provide filtered reflected signals back to the antenna 101. This filtering provides for frequency selective backscatter modulation by allowing the backscatter modulator 103 to modulate signals within the passband while generally suppressing modulation of signals outside the passband.

In some examples, the filter 102 may be implemented using a tunable filter. A tunable filter may use switches such as field effect transistors (FETs) or PIN diodes to adjust one or more parameters of the filter 102, such as the passband and/or stopband frequencies of the filter 102. The tunable filter may use one or more voltage controlled elements such as varactors to adjust the passband and/or stopband frequencies. Such a tunable filter may be adjusted under the control of the logic 107 to yield a digitally tuned filter passband and stopband. The ability to tune the filter 102 may allow the wireless device to adapt to different communication channels or frequency bands based on commands received through the receiver 104 or based on control methods executed by the logic 107. In some examples, logic 107 may control a tunable filter 102 to sequentially or randomly switch among specific channels, such as Bluetooth Low Energy advertising channels 37, 38, or 39 as specified by the Bluetooth standard. In some examples, logic 107 may coordinate a schedule for the use of specified channels, and thus a schedule for the tuning of filter 102, with an access point, a carrier source, or a peer in a peer-to-peer connection. In some examples, logic 107 may coordinate a schedule for the use of specific channels with a cellular base station such as a Next Generation NodeB, or gNodeB.

Examples of devices described herein may include one or more backscatter modulators, such as the backscatter modulator 103 of FIG. 1. The backscatter modulator 103 is coupled to the filter 102 and to the logic 107. The backscatter modulator 103 may be implemented using a switched-impedance backscatter modulator having two or more impedances that can be switched using a control signal to provide a time-varying reflection coefficient at the antenna 101. In some examples, two impedances may be used to provide a two-state binary amplitude shift keying (ASK) or phase shift keying (PSK) modulation. In other examples, multiple impedances may be used to yield a single-sideband modulation or a quadrature amplitude modulation (QAM). In further examples, pulse position modulation such as delta-sigma modulation may be used to generate arbitrary backscatter modulation waveforms. The backscatter modulator 103 may include one or more variable impedance elements such as field effect transistors (FETs), varactor diodes, or PIN diodes. For example, the backscatter modulator 103 may include a transistor that switches between two impedance states in accordance with transmit data provided by the logic 107. The backscatter modulator 103 may include RF switches implemented using complementary metal oxide semiconductor (CMOS) transistors integrated within an integrated circuit alongside other circuit elements such as logic 107, filter 102, receiver 104, or any other combination of circuit elements. The time-varying reflection coefficient generated by the backscatter modulator 103 provides a modulated backscatter signal that may be re-radiated by the antenna 101. The switching impedances Z1 and Z2 of the backscatter modulator 103 may be selected in some examples based on the differential reflection coefficient within the passband of the filter 102 (e.g., to maximize the differential reflection coefficient within the passband of the filter 102). When the backscatter modulator 103 switches between impedance states, a reflection coefficient may be presented at the antenna 101 based, at least in part, on the characteristics of the filter 102 and the impedances presented by the backscatter modulator 103.

Examples of devices described herein may include a receiver, such as the receiver 104 of FIG. 1. The receiver 104 is coupled to the filter 102 and to the logic 107. The receiver 104 may receive and demodulates incident radio frequency signals. In some examples, the receiver 104 may receive and demodulate incident radio frequency signals within the passband of the filter 102 to receive digital commands and/or data. The receiver 104 may communicate received digital commands and/or data to the logic 107. In some examples, the receiver 104 may include an envelope detector, such as a diode envelope detector or a transistor based envelope detector. In some examples, the receiver 104 may include a heterodyne (direct conversion) or superheterodyne receiver. The filter 102 may serve as a preselection filter for the receiver 104, rejecting and/or attenuating out-of-band or out-of-channel signals incident on the antenna 101. This attenuation may reduce the likelihood that such out-of-band or out-of-channel signals interfere with the reception of signals within the passband. For example, in an example where the receiver 104 is implemented using a wideband envelope detector, the filter 102 may be used to reject signals outside the passband to provide improved receiver performance. The preselection function of the filter 102 may mitigate adjacent channel interference and allow the receiver 104 to operate with reduced power consumption while maintaining performance even in the presence of strong interfering signals outside the passband.

Examples of devices described herein may include an energy harvester, such as the energy harvester 105 of FIG. 1. The energy harvester 105 is coupled to the filter 102 and to the energy storage 106. Note that the energy harvester 105 and the energy storage 106 are optional. The energy harvester 105 may be implemented using a rectifier in some examples to convert radio frequency energy incident on the antenna 101 to direct current (dc) power. The rectifier may be implemented using one or more diodes or field effect transistors in a circuit such as a half-wave rectifier, a full-wave rectifier, a Villard or Greinacher voltage multiplier, or other rectifier circuits. In some examples, the energy harvester 105 may be implemented using a thermoelectric energy harvester that converts radio frequency energy to heat, and then heat to dc power using thermoelectric conversion, for example via the Seebeck effect. The energy harvester 105 may provide harvested dc power to the energy storage 106 for use by other components of the wireless device.

The energy storage 106 may accordingly store energy generated by the energy harvester 105. The energy storage 106 and/or the energy harvester 105 may provide all and/or a portion of power used by the logic 107 and/or other circuit elements of the wireless device. The energy storage 106 may be implemented using a capacitor, a battery, and/or other energy storage device operable to store energy and/or receive energy at least in part from the energy harvester 105. The energy storage 106 may store harvested energy and provides this dc power to the logic 107 and/or other components that utilize power for operation. The energy storage 106 may include a voltage regulator or power management circuitry to provide stable supply voltages to connected components.

Examples of devices described herein may include logic, such as logic 107 of FIG. 1. The logic 107 is coupled to the backscatter modulator 103, the receiver 104, and the optional energy storage 106. The logic 107 may include digital logic, such as combinatorial and/or finite state machine (FSM) logic. In some examples, the logic 107 includes an embedded processor core such as the ARM Cortex series or the RISC-V series, or other embedded processor cores. The logic 107 may include volatile memory, such as digital register storage, static random access memory (RAM), or dynamic random access memory. The logic 107 may include non-volatile memory such as read-only memory (ROM), electrically erasable programmable read only memory (EEPROM), Flash memory, phase change memory, or ferroelectric memory. The logic 107 may receive digital commands and/or data and may control the operation of the backscatter modulator 103 by providing control signals that cause the backscatter modulator 103 to switch between impedance states, such as in accordance with transmit data.

Accordingly, devices described herein may be used to backscatter transmit data. The transmit data may be stored in memory within or coupled to the logic 107 or may be generated by the logic 107 based on sensor readings or other inputs. In examples where the filter 102 is implemented as a tunable filter, the logic 107 may control the tuning of the filter 102 to adjust its passband and/or stopband frequencies. The logic 107 may receive power from the energy storage 106 and timing signals from clock 108.

Examples of devices described herein may include a clock, such as a clock circuit 108. The clock circuit 108 is coupled to the logic 107. The clock circuit 108 may supply a clock signal for the internal operation of some or all of the digital circuitry within the logic 107. In some examples, the clock circuit 108 may include a resistor-capacitor (RC) oscillator, an inductor-capacitor (LC) oscillator, a quartz crystal oscillator, a ceramic resonator oscillator, or other oscillator circuits. The clock circuit 108 may be implemented using a phase locked loop (PLL) or a delay locked loop (DLL) in which one oscillator is stabilized with respect to a reference frequency. In some examples, one oscillator may include an RC oscillator, while the reference frequency may be derived from a stable source such as a crystal or ceramic resonator oscillator. In some examples, one oscillator may be implemented using an RC oscillator, while the reference frequency may be derived from radio-frequency signals incident on the antenna 101. In some examples, calibration symbols having a known timing may be transmitted by another device and received as incident radio frequency signals on the antenna 101. Such calibration symbols may be received by the receiver 104 and provided to the logic 107 for the purpose of stabilizing the frequency and/or phase of the clock circuit 108. In some examples, calibration symbols may be derived from the envelope of a radio frequency signal incident on antenna 101. Envelope derived calibration symbols may include the duration of a data packet, the interval between two data packets, or variations in amplitude within the duration of a data packet. In some cases, specific data packets may include specified data rates that when received by the device of FIG. 1 are used to calibrate the frequency of the clock circuit 108. In one example, an incident Bluetooth Low Energy signal may include frequency shift keying modulation at a rate of 1 megabit per second, and the device of FIG. 1 may adjust the frequency of clock circuit 108 to have a desired frequency relationship between the frequency of clock circuit 108 and the modulation rate of the incident signal. In some examples, clock circuit 108 may be adjusted such that its frequency is the same as the modulation rate of the incident signal, or four times the modulation rate of the incident signal, or eight times the modulation rate of the incident signal. In some examples, clock circuit 108 is adjusted to yield a rational fraction such as F=a*m/b where F corresponds to the frequency of clock circuit 108, m is the modulation rate of the incident signal, and a and b are any integers. The modulation rate of the incident signal may be derived from any type of demodulation of the incident signal, including amplitude demodulation, envelope demodulation, frequency demodulation, phase demodulation, or quadrature phase demodulation. In some examples, a modulation rate of one component of the incident signal may be used, for example a modulation rate of one subcarrier of an incident orthogonal frequency division multiplexed (OFDM) signal may be used to adjust the frequency of clock circuit 108.

Any of a variety of devices may incorporate the components of FIG. 1 and utilize the device of FIG. 1 to implement low power communication. For example, mobile phone(s), IoT devices, headphones, ear buds, wearable devices, sensors, appliances, computers, tags such as RFID tags, smart labels, memory devices, vehicles, or other devices may include the components of FIG. 1 for communication.

It should be further appreciated that some or all elements 101-108 may be integrated into a single chip such as an application specific integrated circuit (ASIC), or combined with an existing processor onto a single chip.

During operation, the wireless device of FIG. 1 may have incident radio frequency signals on the antenna 101. The incident signals may be filtered by filter 102 to pass frequencies within the passband of the filter 102 while attenuating frequencies outside the passband. The filtered incident signals are provided to the backscatter modulator 103. The filtered incident signals may also be provided to the receiver 104 and/or the energy harvester 105. The energy harvester 105 may convert a portion of the filtered incident signal energy to dc power, which may be stored in the energy storage 106. Energy in the energy storage 106 may be used by the logic 107 and/or other components described herein. The receiver 104 may demodulate the filtered incident signals to extract digital commands and data, which are provided to the logic 107. The logic 107 processes the received commands and/or data.

The logic 107 may control the backscatter modulator 103 by providing control signals that cause the backscatter modulator 103 to switch between impedance states in accordance with transmit data. As the backscatter modulator 103 switches impedances, it creates a time-varying reflection coefficient from the perspective of the antenna 101. This time-varying reflection coefficient modulates the filtered incident carrier signal, creating modulated backscatter signals that are reflected back toward the filter 102. The filter 102 filters the reflected signals, passing frequencies within its passband while attenuating frequencies outside the passband. The filtered reflected signals are provided to the antenna 101. The antenna 101 re-radiates the filtered backscatter signals into the environment. The filter 102 accordingly may filter both the incident signals and the reflected signals. Accordingly, the wireless device may backscatter modulated signals within the passband of the filter 102 while suppressing backscatter of signals outside the passband. This frequency selective backscatter operation may reduce spectrum pollution by reducing and/or preventing the modulation of out-of-band or out-of-channel incident signals that may be present in the environment. For example, if the filter 102 has a passband corresponding to Wi-Fi channel 1 (e.g., 2401-2423 MHz), the wireless device may backscatter modulated signals within Wi-Fi channel 1 while suppressing backscatter of signals in Wi-Fi channels 6 and 11 or in other frequency bands outside the passband. The frequency selective operation may allow the wireless device to coexist with other wireless communication systems operating in nearby frequency bands without causing prohibitive interference to those systems.

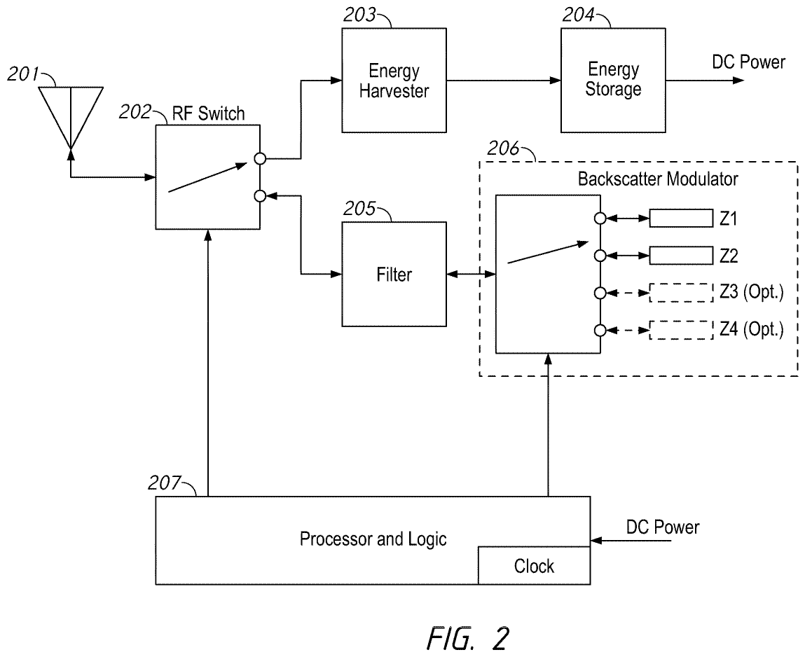

FIG. 2 is a block diagram of a wireless device incorporating a frequency selective backscatter modulator arranged in accordance with examples described herein. The wireless device includes an antenna 201 coupled to an RF switch 202. The RF switch 202 is coupled to an energy harvester 203 and to a filter 205. The energy harvester 203 is coupled to an energy storage 204. The filter 205 is coupled to a backscatter modulator 206. The backscatter modulator 206 is coupled to logic 207. The logic 207 is coupled to the RF switch 202, backscatter modulator 206, and may be coupled to or include a clock circuit.

The example wireless device of FIG. 2 differs from the wireless device of FIG. 1 in that the RF switch 202 is positioned between the antenna 201 and other downstream components, including the energy harvester 203 and the filter 205. The RF switch 202 allows the wireless device to selectively route incident signals from the antenna 201 to different signal paths depending on the operational mode of the device. The logic 207 may provide control signals to the RF switch 202 to determine whether incident signals are directed to the energy harvester 203 or to the filter 205 and backscatter modulator 206. Various components in FIG. 2 may be implemented by and/or used to implement similarly named components as shown and described with reference to FIG. 1. For example, the antenna 201, energy harvester 203, energy storage 204, filter 205, backscatter modulator 206, logic 207, and/or clock circuit of FIG. 2 may be implemented using examples of those components as shown and described with reference to FIG. 1, including antenna 101, energy harvester 105, energy storage 106, filter 102, backscatter modulator 103, logic 107, and/or clock circuit 108.

The example in FIG. 2 is exemplary. Additional, fewer, and/or different components may be provided in other examples.

Examples of devices described herein may include one or more switches to select a path for incoming incident signals, such as the RF switch 202 of FIG. 2. The RF switch 202 is coupled between the antenna 201 and downstream components including the energy harvester 203 and the filter 205. The RF switch 202 selectively routes incident signals from the antenna 201 to one of at least two signal paths based on a control signal provided by the logic 207. In a first position, the RF switch 202 couples the antenna 201 to the energy harvester 203, allowing a wide range of incident radio frequencies to pass through to the energy harvester 203 for energy harvesting. In a second position, the RF switch 202 couples the antenna 201 to the filter 205, enabling a filtered signal to be provided to the backscatter modulator 206. The RF switch 202 may be implemented using one or more transistors, PIN diodes, or other switching elements that can be controlled by digital logic signals. The logic 207 may be used to determine the periods of time during which backscatter modulation is to be used and controls the RF switch 202 accordingly. When backscatter modulation is not needed, the logic 207 controls the RF switch 202 to connect the antenna 201 to the energy harvester 203, allowing energy harvesting from a range of incident frequencies that is larger than the frequencies provided to backscatter modulator 206 through the filter 205. This may allow higher average power to be harvested if there is out-of-band energy present in the environment that would have been rejected in the stopband of the filter 205.

When the RF switch 202 is in the first position connecting the antenna 201 to the energy harvester 203, the energy harvester 203 can harvest energy from any available radio frequency signals within the bandwidth of the antenna 201, regardless of the passband of the filter 205. This allows the wireless device to harvest energy from a wider range of frequencies when backscatter modulation is not active, potentially increasing the amount of harvestable energy available to power the device.

The backscatter modulator 206 may switch between impedance states in accordance with transmit data provided by the logic 207. The time-varying reflection coefficient generated by the backscatter modulator 206 creates a modulated backscatter signal that is filtered by the filter 205 and the filtered reflected signal re-radiated by the antenna 201 through the RF switch 202. Accordingly, control signals provided by the logic 207 may maintain the RF switch 202 in a position to couple the antenna 201 to the filter 205 and backscatter modulator 206 during times where transmit data is to be backscattered into the environment.

The logic 207 may control the operation of the RF switch 202 by providing control signals that determine whether the antenna 201 is coupled to the energy harvester 203 or to the filter 205 and backscatter modulator 206. The logic 207 may determine the periods of time during which backscatter modulation is to be used based on transmit data to be communicated and controls the RF switch 202 accordingly. When backscatter communication is to occur, the logic 207 may provide a control signal to the RF switch 202 to connect the antenna 201 to the filter 205. The logic 207 may provide control signals to the backscatter modulator 206 that cause the backscatter modulator 206 to switch between impedance states in accordance with transmit data. When backscatter communication is not to be used, the logic 207 may provide one or more control signals to the RF switch 202 to connect the antenna 201 to the energy harvester 203, allowing energy harvesting from a wide range of incident frequencies.

During operation, the wireless device of FIG. 2 receives incident radio frequency signals through the antenna 201. The logic 207 may determine whether backscatter communication is to be used. In some examples, the logic 207 may control the RF switch 202 for backscatter communication at particular times (e.g., duty cycles or backscatter transmission schedules). In some examples, the logic 207 may control the RF switch 202 based on transmit data to be communicated (e.g., when transmit data is provided to and/or stored at a location accessible to the logic 207). In some examples, the logic 207 may control the RF switch for backscatter modulation only during times in which an incident carrier signal is known to be present, such as enabling backscatter modulation only when energy harvester 203 detects an incident carrier signal exceeding a specified threshold power.

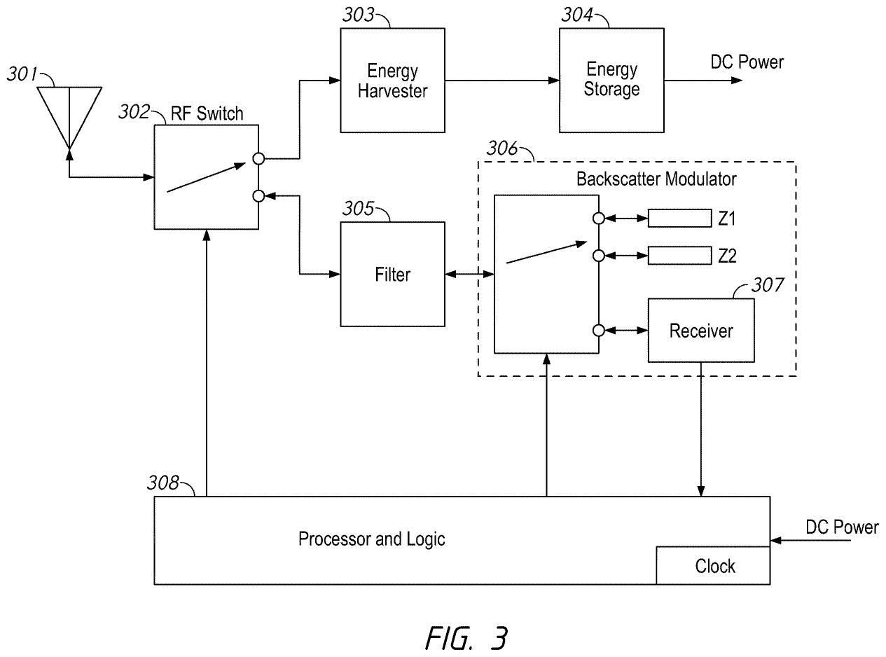

FIG. 3 is a schematic illustration of an apparatus including a frequency selective backscatter modulator arranged in accordance with examples described herein. The wireless device includes an antenna 301 coupled to an RF switch 302. The RF switch 302 is coupled to an energy harvester 303 and to a filter 305. The energy harvester 303 is coupled to an energy storage 304. The filter 305 is coupled to a backscatter modulator 306, which may include or be coupled to receiver 307. The backscatter modulator 306 and the receiver 307 are each coupled to logic 308. A clock circuit may be included in and/or coupled to the logic 308.

The wireless device of FIG. 3 differs from the wireless device of FIG. 2 in that the receiver 307 is positioned after the filter 305 and shares the filtered signal path with the backscatter modulator 306. This architecture may allow the receiver 307 to benefit from the preselection filtering provided by the filter 305, which rejects and/or attenuates out-of-band or out-of-channel signals incident on the antenna 301.

The example in FIG. 3 is exemplary. Additional, fewer, and/or different components may be provided in other examples.

The antenna 301, RF switch 302, energy harvester 303, energy storage 304, filter 305, logic 308, and clock circuit may be implemented by and/or used to implement like named components as described with respect to FIG. 1 and FIG. 2. For example, the RF switch 302 may be implemented by and/or used to implement the RF switch 202 of FIG. 2. The antenna 301, energy harvester 303, energy storage 304, filter 305, components of the backscatter modulator 306, and logic 308 may be implemented and operated as described herein with reference to antenna 101, energy harvester 105, energy storage 106, filter 102, backscatter modulator 103, and logic 107, respectively, for example. In some examples, however, the backscatter modulator 306 may include receiver 307.

As described with respect to FIG. 2, when the RF switch 302 is in a position connecting the antenna 301 to the filter 305, incident signals pass through the filter 305 to reach the backscatter modulator 306. In the example of FIG. 3, in this position, the filtered incident signals may also be provided to the receiver 307.

The RF switch 302 of FIG. 3 may be used to switch antenna 301 between an unfiltered path, leading to energy harvester 303, and a filtered path, leading to backscatter modulator 306 and receiver 307. In some examples, RF switch 302 is controlled by logic 308. RF switch 302 may be set to a first position to allow energy harvester 303 to harvest any available radio frequency energy, regardless of the passband of filter 305 when neither backscatter communication nor reception of incoming signals is to be performed. When either backscatter communication or reception is to be performed, logic 308 may control RF switch 302 into a second position to allow a filtered signal path between antenna 301 and the backscatter modulator and receiver. Accordingly, control signals provided by the processor logic 308 may indicate an energy harvesting mode or a mode for backscatter communication or reception of incoming or outgoing signals.

Examples of devices described herein may accordingly include receivers, such as receiver 307 of FIG. 3. The receiver 307 may be integrated with and/or coupled to backscatter modulators described herein, such as backscatter modulator 306. The receiver 307 is accordingly coupled to the filter 305 and to the logic 308. The receiver 307 may receive and/or demodulates incident radio frequency signals that have been filtered by the filter 305. In some examples, the receiver 307 may include an envelope detector, such as a diode envelope detector. In other examples, the receiver 307 may include a heterodyne (direct conversion) or superheterodyne receiver. The filter 305 may accordingly serves as a preselection filter for the receiver 307, rejecting out-of-band or out-of-channel signals incident on the antenna 301 to reduce the likelihood that such undesired signals interfere with the reception of signals within the passband. For example, if the receiver 307 is implemented using a wideband envelope detector, the filter 305 may be used to reject signals outside the passband to improve receiver performance. The preselection function of the filter 305 may mitigate adjacent channel or other interference and may allow the receiver 307 to operate with reduced power consumption while maintaining performance even in the presence of interfering signals outside the passband. The receiver 307 may demodulate the filtered incident signals to extract digital commands and data, which may be communicated to the logic 308.

In some examples, the filter 305 may have a passband corresponding to a channel of a communication standard. For example, the filter 305 may have a passband corresponding to a single Wi-Fi channel or a single Bluetooth channel. In some examples, the filter 305 may have a passband corresponding to one of the three non-overlapping Wi-Fi channels 1, 6, or 11, or one of the three Bluetooth advertising channels 37, 38, or 39. In such examples, the passband of the filter 305 serves as a channel-selection filter for the receiver 307. If the receiver 307 is subject to desensitization due to the presence of strong interfering signals outside of the passband of the filter 305, the presence of the filter 305 may mitigate this interference by performing a preselection function. This preselection may provide benefit even when the receiver 307 is designed with frequency selectivity in mind, as in the case of a heterodyne or superheterodyne receiver. The receiver 307 may in some examples consume a low amount of dc power, and the front end structure of the receiver 307 may accordingly be vulnerable to overload from strong adjacent signals. In such cases, the preselection function of the filter 305 may aid in mitigating adjacent channel or other interference to improve receiver performance.

During operation, the wireless device of FIG. 3 receives incident radio frequency signals through the antenna 301. The logic 308 determines whether backscatter communication or signal reception is needed. When neither backscatter communication nor reception is needed, the logic 308 controls the RF switch 302 to connect the antenna 301 to the energy harvester 303. In this position, incident signals from the antenna 301 pass through the RF switch 302 to the energy harvester 303, which converts the radio frequency energy to dc power stored in the energy storage 304. This allows the wireless device to harvest energy from any available incident signals within the bandwidth of the antenna 301, without the filtering that would be imposed by the filter 305.

When either backscatter communication or reception is desired, the logic 308 controls the RF switch 302 to connect the antenna 301 to the filter 305. In this position, incident signals from the antenna 301 pass through the RF switch 302 to the filter 305, which filters the incident signals to pass frequencies within its passband while attenuating frequencies outside the passband. The filtered incident signals reach both the backscatter modulator 306 and the receiver 307. The receiver 307 demodulates the filtered incident signals to extract digital commands and data, which are provided to the logic 308. The logic 308 processes the received commands and data and may store, display, or take other action with the received commands and data.

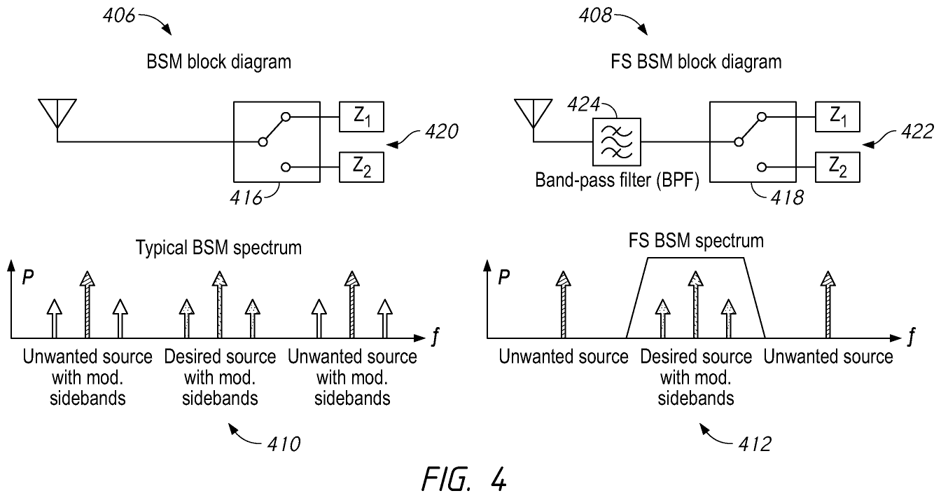

FIG. 4 is a comparative diagram illustrating a backscatter modulator and a frequency-selective backscatter modulator with corresponding spectra. The figure includes a backscatter modulator 406 represented by a block diagram and an associated spectrum 410, alongside a frequency selective backscatter modulator 408 represented by a block diagram and an associated spectrum 412. The backscatter modulator 406 includes a switch 416 coupled to impedances 420. The frequency selective backscatter modulator 408 includes a filter 424, a switch 418, and impedances 422. Both block diagrams show an antenna coupled to the respective modulator components.

FIG. 4 illustrates examples of differences between a backscatter modulator architecture without filters positioned as described herein and a frequency selective backscatter modulator architecture utilizing a filter. These differences are shown and discussed to demonstrate examples of spectral consequences of adding a filter in the signal path. The backscatter modulator 406 does not utilize a filter, while the frequency selective backscatter modulator 408 introduces an inline filter element to provide frequency selectivity in the backscatter operation.

The frequency selective backscatter modulator 408 of FIG. 4 may be implemented using backscatter modulators described herein, such as backscatter modulator 103 of FIG. 1, backscatter modulator 206 of FIG. 2, and/or backscatter modulator 306 of FIG. 3.

The example in FIG. 4 is exemplary. Additional, fewer, and/or different components may be provided in other examples. Additionally, the performance demonstrated in FIG. 4 is provided to facilitate appreciation of the use of the filter. It is to be understood that different performance specifics may be achieved in various examples.

The backscatter modulator 406 in the left portion of FIG. 4 represents does not include a filter between the antenna and the switch 416. The backscatter modulator 406 includes an antenna coupled to a switch 416 that provides switching between multiple impedances 420. In the example shown, the impedances 420 include two impedance states labeled Z1 and Z2, representing the switchable impedances that create the time-varying reflection coefficient at the antenna. The switch 416 may receive control signals that cause it to alternate between coupling the antenna to the first impedance Z1 or the second impedance Z2 of the impedances 420. The switch 416 may be implemented using a transistor such as a field effect transistor (FET), a PIN diode, or a varactor diode that presents different impedances based on its bias condition. When the switch 416 toggles between the impedances 420 in accordance with transmit data, the backscatter modulator 406 creates a time-varying reflection coefficient at the antenna that modulates incident carrier signals across the entire bandwidth of the antenna.

The spectrum 410 associated with the backscatter modulator 406 shows the frequency-domain representation of the backscattered signal generated by the backscatter modulator 406. The spectrum 410 depicts power P versus frequency f and illustrates modulation sidebands appearing at multiple frequency locations across the bandwidth. In the spectrum 410, unwanted sources at lower frequencies generate modulation sidebands indicated with the ‘unwanted source’ labels, while a desired source at a desired frequency generates modulation sidebands indicated with the ‘desired source’ label, and unwanted sources at higher frequencies generate additional modulation sidebands. The spectrum 410 demonstrates that the backscatter modulator 406 modulates every incident signal within the antenna bandwidth, including unwanted signals outside the desired carrier band. This wideband modulation behavior creates spectrum pollution by generating modulation sidebands from undesired incident signals, which may interfere with other nearby communication links operating at those frequencies.

The frequency selective backscatter modulator 408 in the right portion of FIG. 4 represents a frequency selective backscatter modulator architecture arranged in accordance with examples described herein. The frequency selective backscatter modulator 408 includes an antenna coupled to a filter 424, which is in turn coupled to a switch 418 that provides switching between multiple impedances 422. The filter 424 is positioned in the signal path between the antenna and the switch 418. The filter 424 includes a bandpass filter that filters both incident signals from the antenna and reflected signals from the switch 418 and impedances 422. The filter 424 includes a passband that corresponds to a frequency band, such as a particular Wi-Fi channel or Bluetooth channel. In the example shown, the impedances 422 include two impedance states labeled Z1 and Z2, similar to the impedances 420 of the backscatter modulator 406. The switch 418 receives control signals that cause it to alternate between coupling the filter 424 to the first impedance Z1 or the second impedance Z2 of the impedances 422. While two impedances are shown, any number may be used. The switch 418 may be implemented using, for example, a transistor such as a field effect transistor (FET), a PIN diode, or a varactor diode.

The filter 424 performs dual filtering functions in the frequency selective backscatter modulator 408. When incident signals arrive at the antenna from the environment, the filter 424 filters these incident signals to pass frequencies within its passband while attenuating frequencies outside the passband. The filtered incident signals are provided to the switch 418 and impedances 422. When the switch 418 toggles between the impedances 422 in accordance with transmit data, the switching creates reflected signals that travel back toward the antenna. The filter 424 also filters these reflected signals, passing frequencies within its passband while attenuating frequencies outside the passband. The filtered reflected signals are provided to the antenna for re-radiation into the environment. This dual filtering action enables the frequency selective backscatter modulator 408 to selectively modulate incident signals within the passband of the filter 424 while suppressing modulation of incident signals outside the passband.

The spectrum 412 associated with the frequency selective backscatter modulator 408 shows the frequency-domain representation of the backscattered signal generated by the frequency selective architecture. The spectrum 412 depicts power P versus frequency f and illustrates that modulation sidebands appear at the desired source frequency indicated with the central sideband arrows, while unwanted sources at other frequencies do not generate modulation sidebands. In the spectrum 412, sources outside the passband of the filter 424 are not modulated and therefore do not produce sidebands in the backscattered signal. The spectrum 412 demonstrates that the frequency selective backscatter modulator 408 modulates incident signals within the passband of the filter 424 while suppressing modulation of incident signals outside the passband. This frequency selective behavior reduces spectrum pollution by preventing the generation of modulation sidebands from undesired incident signals outside the desired carrier band.

During operation, the backscatter modulator 406 receives incident signals at the antenna spanning a wide range of frequencies within the antenna bandwidth. The incident signals may include a desired carrier source at a target frequency as well as unwanted sources at other frequencies. The switch 416 of the backscatter modulator 406 may toggle between the impedances 420 Z1 and Z2 in accordance with transmit data, creating a time-varying reflection coefficient at the antenna. This time-varying reflection coefficient modulates all incident signals within the antenna bandwidth, generating modulation sidebands at each incident frequency as shown in the spectrum 410. The resulting backscattered signal includes desired modulation sidebands from the desired carrier source as well as unwanted modulation sidebands from the unwanted sources, leading to spectrum pollution across multiple frequency bands.

In contrast, the frequency selective backscatter modulator 408 receives incident signals at the antenna spanning a wide range of frequencies. The incident signals pass through the filter 424, which filters the incident signals to pass frequencies within its passband while attenuating frequencies outside the passband. The filtered incident signals reaching the switch 418 include the desired carrier source within the passband of the filter 424 but exclude sources outside the passband. The switch 418 of the frequency selective backscatter modulator 408 toggles between the impedances 422 Z1 and Z2 in accordance with transmit data, creating reflected signals that are modulated versions of the filtered incident signals. The reflected signals pass back through the filter 424, which filters the reflected signals to pass frequencies within its passband. The filtered reflected signals are provided to the antenna for re-radiation. As shown in the spectrum 412, the resulting backscattered signal includes desired modulation sidebands from the desired carrier source within the passband of the filter 424, but does not include unwanted modulation sidebands from unwanted sources outside the passband. The filter 424 prevents the switch 418 and impedances 422 from modulating incident signals outside the passband, thereby reducing spectrum pollution.

The comparison illustrated in FIG. 4 demonstrates advantages of examples of frequency selective backscatter modulation in environments where multiple incident signals are present across different frequency bands. For example, in an environment including Wi-Fi and Bluetooth communication signals as well as cellular signals, the backscatter modulator 406 would modulate all incident signals within the antenna bandwidth, creating unwanted interference across multiple frequency bands. The frequency selective backscatter modulator 408 with the filter 424 modulates incident signals within a selected frequency band corresponding to the passband of the filter 424, such as a particular Wi-Fi channel or Bluetooth advertising channel, or a specified cellular channel, while avoiding or reducing modulation of incident signals in other frequency bands. This frequency selective operation allows examples of the frequency selective backscatter modulator 408 to coexist with other wireless communication systems operating in nearby frequency bands by reducing the interference that may otherwise be caused to those systems.

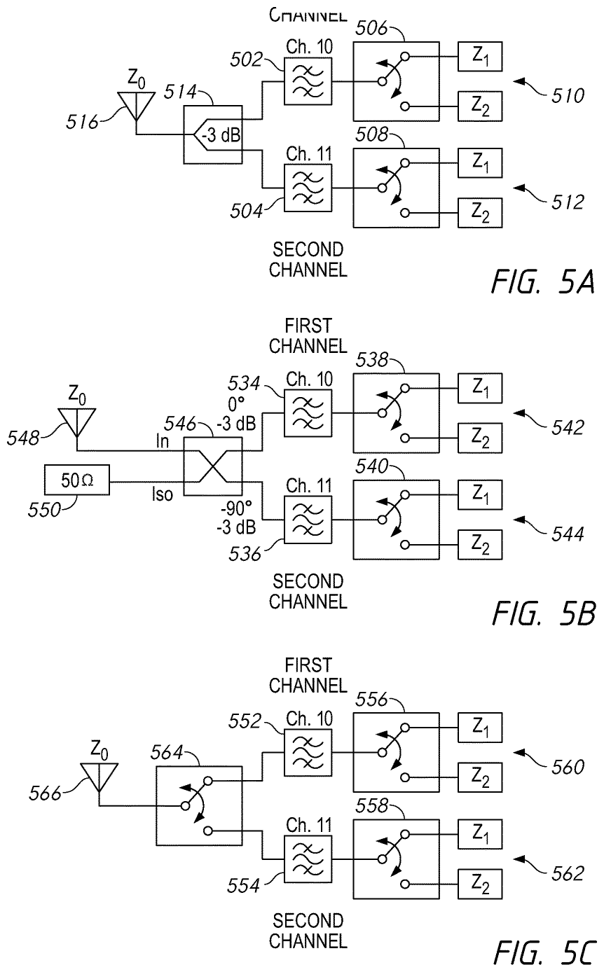

FIG. 5A is a schematic diagram of a frequency selective backscatter modulator using a splitter and respective filters and switches for first and second channels, arranged in accordance with examples described herein. The apparatus includes an antenna 516 coupled to a power splitter 514. The power splitter 514 is coupled to a first channel path and a second channel path. The first channel path includes a filter 502 coupled to a switch 506, which is coupled to impedances 510. The second channel path includes a filter 504 coupled to a switch 508, which is coupled to impedances 512.

The example apparatus of FIG. 5A differs from the example apparatus of FIG. 1 in that FIG. 5A includes two separate channel paths, each with its own filter and backscatter modulator, coupled to the antenna through a power splitter. This architecture may allow for examples of backscatter modulation in two different frequency channels, allowing the apparatus to backscatter independent data streams in two separate Bluetooth, Wi-Fi, or cellular channels. The communication in the two channels may occur simultaneously, or partially simultaneously, or may not be simultaneous. The communication in the two channels may occur without time-division multiplexing. The example dual-channel architecture of FIG. 5A may provide increased data throughput compared to single-channel architectures in some examples.

The antenna 516, filter 502, filter 504, switch 506, switch 508, impedances 510, and impedances 512 may be implemented by and/or used to implement components described herein, such as filter 102 and the backscatter modulator 103 of FIG. 1. The backscatter modulator 103 of FIG. 1, for example, includes a switch and impedances, which may be the switch 506 and impedances 510, for example.

The example in FIG. 5A is exemplary. Additional, fewer, and different components may be provided in other examples. While two channels are shown, any number may be provided.

The power splitter 514 is coupled to the antenna 516 and may divide incident signals received from the antenna 516 into two signal paths corresponding to a first channel and a second channel. The power splitter 514 may be implemented using a three-port device having an input port coupled to the antenna 516 and two output ports, each coupled to one of the channel paths. The power splitter 514 may include a resistive power divider, a Wilkinson power divider, or another type of power splitting network. In some examples, the power splitter 514 may divide incident power equally between the two output ports, providing half of the incident signal power to each channel path. Other fractions of divided power may be used in other examples. The power splitter 514 may in some examples introduce insertion loss between the antenna 516 and each channel path. In the 2.4 GHz ISM band, the power splitter 514 may introduce insertion loss in the range of 3 to 4 dB. The power splitter 514 may provide port-to-port isolation between the output ports, which may suppress and/or reduce interaction between the two channel paths. This isolation may allow the two channel paths to operate independently, allowing simultaneous or partially simultaneous (e.g., overlapping) backscatter modulation in two different frequency channels without crosstalk that interferes with the other channel.

The filter 502 is coupled to one output port of the power splitter 514 and is positioned in the first channel path. The filter 502 includes a bandpass filter having a passband corresponding to a first predetermined channel. In some examples, the first predetermined channel includes a first Bluetooth channel, such as Bluetooth channel 37 (2.401-2.403 GHz) or Bluetooth channel 38 (2.425-2.427 GHz). In other examples, the first predetermined channel includes a first Wi-Fi channel, such as Wi-Fi channel 1 (2401-2423 MHz). The filter 502 may include an inductor-capacitor filter, a microstrip filter, a low-temperature cofired ceramic (LTCC) filter, a surface acoustic wave (SAW) filter, or a bulk acoustic wave (BAW) filter. In examples where the first predetermined channel includes Wi-Fi channel 1, the filter 502 may include a Qorvo Inc. QPQ1905 BAW filter designed for Wi-Fi channel 1 with a passband of approximately 2401-2423 MHz. The filter 502 filters incident signals from the power splitter 514 to pass frequencies within the passband of the first predetermined channel while attenuating frequencies outside the passband. The filtered incident signals are provided to the switch 506. The filter 502 also filters reflected signals from the switch 506 and impedances 510, providing filtered reflected signals back to the power splitter 514. This dual filtering action may provide frequency selective backscatter modulation in the first predetermined channel.

The switch 506 is coupled to the filter 502 and to the impedances 510. The switch 506 receives control signals that cause the switch 506 to alternate between coupling the filter 502 to different impedances provided by the impedances 510. The switch 506 may include a transistor such as a field effect transistor (FET), a PIN diode, or a varactor diode that presents different impedances based on its bias condition. In some examples, the switch 506 includes a pseudomorphic high electron mobility transistor (pHEMT) FET. Complementary metal oxide semiconductor (CMOS) FETs may also be used and may be integrated into a single chip alongside other circuit elements shown herein. The control signals provided to the switch 506 may include digital signals generated by logic circuitry based on first transmit data to be backscattered in the first predetermined channel. In some examples, when the control signals are at a first level (e.g., a logic zero level), the switch 506 couples the filter 502 to a first impedance state of the impedances 510. When the control signals are at a second logic level (e.g., a logic one level), the switch 506 couples the filter 502 to a second impedance state of the impedances 510. By switching between impedance states in accordance with the first transmit data, the switch 506 creates a time-varying reflection coefficient that modulates filtered incident signals within the passband of the filter 502.

The impedances 510 are coupled to the switch 506 and provide two or more impedance states that the switch 506 can select. In a binary modulation scheme, the impedances 510 include a first impedance Z1 and a second impedance Z2. The switch 506 alternates between coupling the filter 502 to the first impedance Z1 or the second impedance Z2 in accordance with first transmit data. The values of the first impedance Z1 and second impedance Z2 are selected to maximize the differential reflection coefficient within the passband of the filter 502. In some examples, the first impedance Z1 includes a high impedance state, such as an open circuit or a large resistance, while the second impedance Z2 includes a low impedance state, such as a short circuit or a small resistance. The impedances 510 may be implemented using resistors, capacitors, inductors, transistors, or combinations thereof. When the switch 506 toggles between the impedances 510, the changing impedance creates modulated backscatter signals that are filtered by the filter 502 and provided by the power splitter 514 for re-radiation by the antenna 516.

The filter 504 is coupled to another output port of the power splitter 514 and is positioned in the second channel path. The filter 504 includes a bandpass filter having a passband corresponding to a second predetermined channel different from the first predetermined channel. In some examples where the first predetermined channel includes Bluetooth channel 37, the second predetermined channel may include Bluetooth channel 38 or Bluetooth channel 39 (2.478-2.480 GHz). In other examples where the first predetermined channel includes Wi-Fi channel 1,the second predetermined channel may include Wi-Fi channel 11 (2451-2473 MHz). The filter 504 may include an inductor-capacitor filter, a microstrip filter, a low-temperature cofired ceramic (LTCC) filter, a surface acoustic wave (SAW) filter, or a bulk acoustic wave (BAW) filter. In examples where the second predetermined channel includes Wi-Fi channel 11, the filter 504 may include a Qorvo Inc. QPQ1906 BAW filter designed for Wi-Fi channel 11 with a passband of approximately 2451-2473 MHz. The filter 504 filters incident signals from the power splitter 514 to pass frequencies within the passband of the second predetermined channel while attenuating frequencies outside the passband. The filtered incident signals are provided to the switch 508. The filter 504 also filters reflected signals from the switch 508 and impedances 512, providing filtered reflected signals back to the power splitter 514. This dual filtering action allows for frequency selective backscatter modulation in the second predetermined channel, independent of the modulation occurring in the first channel path. In some examples, the channels described correspond to the channels of a cellular communication standard.

The switch 508 is coupled to the filter 504 and to the impedances 512. The switch 508 receives control signals that cause the switch 508 to alternate between coupling the filter 504 to different impedances provided by the impedances 512. The switch 508 may include a transistor such as a field effect transistor (FET), a PIN diode, or a varactor diode that presents different impedances based on its bias condition. In some examples, the switch 508 includes a pseudomorphic high electron mobility transistor (pHEMT) FET. The control signals provided to the switch 508 may include digital signals generated by logic circuitry based on second transmit data to be backscattered in the second predetermined channel. The second transmit data may differ from the first transmit data provided to the switch 506, allowing independent data streams to be backscattered simultaneously in the two different predetermined channels. When the control signals are at a first logic level (e.g., a logic zero level), the switch 508 couples the filter 504 to a first impedance state of the impedances 512. When the control signals are at a second logic level (e.g., a logic one level), the switch 508 couples the filter 504 to a second impedance state of the impedances 512. By switching between impedance states in accordance with the second transmit data, the switch 508 may create a time-varying reflection coefficient that modulates filtered incident signals within the passband of the filter 504.

The impedances 512 are coupled to the switch 508 and provide two or more impedance states that the switch 508 can select. In a binary modulation scheme, the impedances 512 include a first impedance Z1 and a second impedance Z2. The switch 508 alternates between coupling the filter 504 to the first impedance Z1 or the second impedance Z2 in accordance with second transmit data. The values of the first impedance Z1 and second impedance Z2 of the impedances 512 may differ from the impedance values of the impedances 510 in the first channel path, allowing each channel path to include impedance values selected for its respective predetermined channel. In some examples, the same impedance values may be used in multiple channels. The impedances 512 may be implemented using resistors, capacitors, inductors, transistors, or combinations thereof. When the switch 508 toggles between the impedances 512, the changing impedance may create modulated backscatter signals that are filtered by the filter 504 and provided by the power splitter 514 for re-radiation by the antenna 516.

During operation, the apparatus of FIG. 5A receives incident radio frequency signals through the antenna 516. The incident signals include energy across a wide frequency range within the antenna bandwidth. The power splitter 514 divides the incident signals into two paths, providing a portion of the incident signal power to each of the first channel path and the second channel path. In the first channel path, the filter 502 filters the incident signals to pass frequencies within the passband of the first predetermined channel while attenuating frequencies outside this passband. The filtered incident signals from the filter 502 reach the switch 506, which alternates between the impedances 510 in accordance with first transmit data. As the switch 506 toggles between impedance states, it creates modulated backscatter signals that are filtered by the filter 502 and provided back to the power splitter 514.

In the second channel path, the filter 504 may filter the incident signals to pass frequencies within the passband of the second predetermined channel while attenuating frequencies outside this passband. The filtered incident signals from the filter 504 may be provided to the switch 508, which alternates between the impedances 512 in accordance with second transmit data. As the switch 508 toggles between impedance states, it may create modulated backscatter signals that are filtered by the filter 504 and provided back to the power splitter 514. The power splitter 514 may combine the filtered backscatter signals from both channel paths and provides the filtered backscatter signals to the antenna 516 for re-radiation into the environment. The port-to-port isolation of the power splitter 514 may reduce crosstalk between the two channel paths, allowing the two modulators to operate independently. Accordingly, examples of devices may provide wholly or partially simultaneous backscatter modulation, or alternating backscatter modulation, in two different predetermined channels, with each channel carrying independent transmit data. The filter 502 in the first channel path suppresses backscatter of signals outside the first predetermined channel, while the filter 504 in the second channel path suppresses backscatter of signals outside the second predetermined channel. Examples of this frequency selective operation may reduce spectrum pollution by reducing or eliminating modulation of signals outside the two predetermined channels while allowing for increased data throughput through wholly or partially simultaneous transmission in two separate channels in some examples.

FIG. 5B is a schematic diagram of a frequency selective backscatter modulator using a quadrature hybrid coupler and respective filters and switches for first and second channels, arranged in accordance with examples described herein. The apparatus includes an antenna 548 coupled to an input port of a quadrature hybrid coupler 546. The quadrature hybrid coupler 546 includes two output ports coupled to a first channel path and a second channel path, respectively, and an isolation port coupled to a termination impedance 550. The first channel path includes a filter 534 coupled to a switch 538, which is coupled to impedances 542. The second channel path includes a filter 536 coupled to a switch 540, which is coupled to impedances 544.

The apparatus of FIG. 5B differs from the apparatus of FIG. 5A in that FIG. 5B employs a quadrature hybrid coupler 546 in place of the power splitter shown in FIG. 5A, and includes a termination impedance 550 coupled to the isolation port of the quadrature hybrid coupler 546. The quadrature hybrid coupler 546 provides similar functionality to the power splitter of FIG. 5A by dividing incident signals between two channel paths, but examples of the device of FIG. 5B may offer improved port-to-port isolation and phase-shifted outputs. As with FIG. 5A, the device of FIG. 5B may provide wholly or partially simultaneous backscatter modulation in two different frequency channels, allowing the apparatus to backscatter independent data streams in two separate Bluetooth, Wi-Fi, or cellular channels without time-division multiplexing in some examples.

The example in FIG. 5B is exemplary. Additional, fewer, and different components may be provided in other examples.

The antenna 548, filter 534, filter 536, switch 538, switch 540, impedances 542, and impedances 544 may be implemented by and/or used to implement components described herein, such as filter 102 and the backscatter modulator 103 of FIG. 1. The backscatter modulator 103 of FIG. 1, for example, includes a switch and impedances, which may be the switch 538 and impedances 542, for example.

The quadrature hybrid coupler 546 is coupled to the antenna 548 at an input port and divides incident signals received from the antenna 548 into two signal paths corresponding to the first channel and the second channel. The quadrature hybrid coupler 546 includes a four-port device having an input port coupled to the antenna 548, two output ports coupled to the first channel path and the second channel path respectively, and an isolation port coupled to the termination impedance 550. The quadrature hybrid coupler 546 may split incident power between the two output ports with a 90-degree phase difference between the outputs. In some examples, the quadrature hybrid coupler 546 divides incident power equally between the two output ports, providing half of the incident signal power to each channel path with one output leading the other by 90 degrees in phase. Other phase shifts and power splits between channels may be used in other examples. The quadrature hybrid coupler 546 may introduce insertion loss between the antenna 548 and each channel path. In the 2.4 GHz ISM band, the quadrature hybrid coupler 546 may introduce insertion loss in the range of 3 to 4 dB, similar to the power splitter shown in FIG. 5A. The quadrature hybrid coupler 546 may provide port-to-port isolation between the two output ports, which may suppress interaction between the two channel paths. This isolation may allow the two channel paths to operate independently, allowing wholly or partially simultaneous backscatter modulation in two different frequency channels without crosstalk in some examples. The quadrature phase relationship between the two output ports may provide advantages in some applications by reducing the potential for destructive interference between backscattered signals from the two channels when they recombine at the antenna 548. Accordingly, in some examples, each channel of a device described herein may receive a different phase of carrier signal filtered from incident signals on the device for use in modulation described herein.

The termination impedance 550 is coupled to the isolation port of the quadrature hybrid coupler 546. The termination impedance 550 generally provides a matched load to the isolation port to absorb power that would otherwise reflect from the isolation port back into the quadrature hybrid coupler 546. In some examples, the termination impedance 550 includes a resistor having an impedance value matched to the characteristic impedance of the quadrature hybrid coupler 546, which is 50 ohms in some examples. The termination impedance 550 may dissipate power that reaches the isolation port, preventing or impeding this power from causing reflections or interactions within the apparatus. When the two channel paths present matched impedances to the two output ports of the quadrature hybrid coupler 546, minimal power may reach the isolation port and the termination impedance 550. However, when the channel paths present mismatched impedances due to the switching action of the backscatter modulators, some power may reach the isolation port and may be absorbed by the termination impedance 550. The presence of the termination impedance 550 accordingly may improve the isolation between the two output ports and may enhance the overall performance of the dual-channel backscatter architecture in some examples.

The filter 534, switch 538, impedances 542, filter 536, switch 540, and impedances 544 may operate in an analogous manner and may be used to implement and/or implemented by the like-named components of FIG. 5A—such as filter 502, switch 506, impedances 510, filter 504, switch 508, and impedances 512.

During operation, the apparatus of FIG. 5B receives incident radio frequency signals through the antenna 548. The incident signals include energy across a wide frequency range within the antenna bandwidth. The quadrature hybrid coupler 546 divides the incident signals into two paths with a phase difference (e.g., a 90-degree phase difference, although other phase differences may be used), providing a portion of the incident signal power to each of the first channel path and the second channel path. In the first channel path, the filter 534 filters the incident signals to pass frequencies within the passband of the first predetermined channel while attenuating frequencies outside this passband. The filtered incident signals from the filter 534 reach the switch 538, which alternates between the impedances 542 in accordance with first transmit data. As the switch 538 toggles between impedance states, it creates modulated backscatter signals that are filtered by the filter 534 and provided back to the quadrature hybrid coupler 546. Simultaneously, in the second channel path, the filter 536 filters the incident signals to pass frequencies within the passband of the second predetermined channel while attenuating frequencies outside this passband. The filtered incident signals from the filter 536 reach the switch 540, which alternates between the impedances 544 in accordance with second transmit data. As the switch 540 toggles between impedance states, it creates modulated backscatter signals that are filtered by the filter 536 and provided back to the quadrature hybrid coupler 546. The quadrature hybrid coupler 546 combines the filtered backscatter signals from both channel paths and provides the combined signal to the antenna 548 for re-radiation into the environment. The quadrature phase relationship between the two output ports of the quadrature hybrid coupler 546 accordingly may reduce the potential for destructive interference between the backscattered signals from the two channels. Power that reaches the isolation port of the quadrature hybrid coupler 546 due to impedance mismatches in the channel paths may be absorbed by the termination impedance 550, preventing or reducing reflections. The port-to-port isolation of the quadrature hybrid coupler 546 may reduce crosstalk between the two channel paths, allowing the two modulators to operate independently. Accordingly, simultaneous or partially simultaneous backscatter modulation in two different predetermined channels may be provided by devices described herein, with each channel carrying independent transmit data. The filter 534 in the first channel path may suppress backscatter of signals outside the first predetermined channel, while the filter 536 in the second channel path may suppress backscatter of signals outside the second predetermined channel. Examples of devices utilizing the architecture of FIG. 5B may provide similar dual-channel backscatter functionality to those using the architecture of FIG. 5A while offering improved isolation and phase characteristics in some examples through the use of the quadrature hybrid coupler 546.

FIG. 5C is a schematic diagram of a frequency selective backscatter modulator using an antenna-side switch and respective filters and switches for first and second channels, arranged in accordance with examples described herein. The apparatus includes an antenna 566 coupled to an antenna-side switch 564. The switch 564 is coupled to a first channel path and a second channel path. The first channel path includes a filter 552 coupled to a switch 556, which is coupled to impedances 560. The second channel path includes a filter 554 coupled to a switch 558, which is coupled to impedances 562.

The apparatus of FIG. 5C differs from the apparatus of FIG. 5A and FIG. 5B in that FIG. 5C employs an antenna-side switch 564 positioned between the antenna 566 and the channel paths, rather than using a power splitter or quadrature hybrid coupler to divide signals between channel paths. Examples of this architecture of FIG. 5C may allow time-division multiplexed backscatter modulation in two different frequency channels, allowing the apparatus to backscatter data streams in two separate Bluetooth, Wi-Fi, and/or cellular channels by switching between channel paths. The antenna-side switch architecture of FIG. 5C may eliminate or reduce insertion loss associated with power splitters and quadrature hybrid couplers shown in FIG. 5A and FIG. 5B, respectively, which may provide improved differential reflection coefficient compared to the diplexer-based architectures in some examples. However, the architecture of FIG. 5C may utilize time-division multiplexing between channels rather than simultaneous or partially simultaneous dual-channel operation.

The antenna 566, filter 552, filter 554, switch 556, switch 558, impedances 560, and impedances 562 may be implemented by and/or used to implement components described herein, such as filter 102 and the backscatter modulator 103 of FIG. 1. The backscatter modulator 103 of FIG. 1, for example, includes a switch and impedances, which may be the switch 556 and impedances 560, for example.

The example in FIG. 5C is exemplary. Additional, fewer, and different components may be provided in other examples.

The switch 564 is coupled to the antenna 566 and selectively routes incident signals received from the antenna 566 to one of two signal paths corresponding to the first channel or the second channel. The switch 564 includes a single-pole, double-throw (SPDT) RF switch having an input port coupled to the antenna 566 and two output ports, each coupled to one of the channel paths. The switch 564 may receive control signals from logic circuitry that determine which output port is coupled to the antenna 566 at any given time. In a first position, the switch 564 couples the antenna 566 to the first channel path including the filter 552. In a second position, the switch 564 couples the antenna 566 to the second channel path including the filter 554. In some examples, the switch 564 may be implemented using an Analog Devices ADG919 RF switch having low insertion loss in the 2.4 GHz ISM band. The insertion loss of the switch 564 may be in the range of 1 to 2 dB in the target band in some examples, which may be lower than the insertion loss of power splitters or quadrature hybrid couplers used in the architectures of FIG. 5A and FIG. 5B. The reduced insertion loss of the switch 564 may allow examples of the apparatus to achieve higher differential reflection coefficients compared to diplexer-based architectures, which may improve backscatter range and link budget. The switch 564 may provide isolation between the two output ports when one port is selected, preventing or reducing signals from one channel path from leaking into the other channel path. The logic circuitry controlling the switch 564 may implement control techniques to allocate time between the two channels based on available carrier power in each channel, data transmission requirements, or other factors. For example, logic circuitry described herein may be used to send a control signal to the switch 564 to have the device backscatter into a first channel when carrier power in the first channel is greater than, or greater by a threshold amount than, carrier power available in the second channel (and vice versa). In some examples, logic circuitry described herein may be used to send a control signal to the switch 564 to have the device backscatter into a first channel when an amount of data to be backscattered into the first channel is greater than, or greater by a threshold amount than, the amount of data to be backscattered into the second channel (and vice versa).

The filter 552, switch 556, impedances 560, filter 554, switch 558, and impedances 562 may operate in an analogous manner and may be used to implement and/or implemented by the like-named components of FIG. 5A and/or FIG. 5B—such as filter 502, switch 506, impedances 510, filter 504, switch 508, and impedances 512.

During operation, the apparatus of FIG. 5C receives incident radio frequency signals through the antenna 566. The incident signals may include energy across a wide frequency range within the antenna bandwidth. Logic circuitry controlling the switch 564 may determine which channel path to activate for backscatter communication based on available carrier power in each channel, data transmission for each channel, or other factors. When the logic circuitry determines that backscatter communication in the first predetermined channel is to be used, the logic circuitry controls the switch 564 to couple the antenna 566 to the first channel path. In this position, incident signals from the antenna 566 pass through the switch 564 to the filter 552, which filters the incident signals to pass frequencies within the passband of the first predetermined channel while attenuating frequencies outside this passband. The filtered incident signals from the filter 552 reach the switch 556, which alternates between the impedances 560 in accordance with first transmit data. As the switch 556 toggles between impedance states, it creates modulated backscatter signals that are filtered by the filter 552 and routed back through the switch 564 to the antenna 566 for re-radiation into the environment. The filter 552 suppresses or reduces backscatter of signals outside the first predetermined channel, which may reduce spectrum pollution.

When the logic circuitry determines that backscatter communication in the second predetermined channel is to be used, the logic circuitry controls the switch 564 to couple the antenna 566 to the second channel path. In this position, incident signals from the antenna 566 pass through the switch 564 to the filter 554, which filters the incident signals to pass frequencies within the passband of the second predetermined channel while attenuating frequencies outside this passband. The filtered incident signals from the filter 554 reach the switch 558, which may alternate between the impedances 562 in accordance with second transmit data. As the switch 558 toggles between impedance states, it creates modulated backscatter signals that are filtered by the filter 554 and routed back through the switch 564 to the antenna 566 for re-radiation into the environment. The filter 554 suppresses backscatter of signals outside the second predetermined channel, which may reduce spectrum pollution.

The logic circuitry may implement channel detection techniques to determine which channel path provides the stronger carrier signal in some examples. For example, logic circuitry may include carrier detectors such as Schottky diode energy detectors coupled to each channel path. The carrier detectors may measure incident carrier power in each channel and provide measurements to the logic circuitry. The logic circuitry may analyze the measurements to determine which channel(s) have carrier power available for backscatter communication, and which channel(s) have more power available than others. The logic circuitry may control the switch 564 to allocate time to the channel having carrier power that meets a predetermined criteria (e.g., the most carrier power or more than a threshold amount of carrier power). Examples of this adaptive channel selection may allow the apparatus to opportunistically use a selected channel which may provide better link conditions at any particular time. Isolation provided by examples of the switch 564 between the two channel paths may prevent or reduce the inactive channel path from loading the antenna 566 when the other channel path is active, which may maintain high differential reflection coefficients in each channel in some examples.

The architecture of FIG. 5C may allow for time-division multiplexed backscatter modulation in two different predetermined channels. Examples arranged in accordance with FIG. 5C may have lower insertion loss compared to the diplexer-based architectures of FIG. 5A and FIG. 5B. The insertion loss of the switch 564 in the target band may be 1 to 2 dB, compared to the 3 to 4 dB insertion loss of power splitters or quadrature hybrid couplers. This reduced insertion loss may provide higher differential reflection coefficients and improved backscatter range and link budget in some examples. In some examples, devices arranged in accordance with the architecture of FIG. 5C may backscatter in channels sequentially through time-division multiplexing rather than simultaneously or partially simultaneously, as may be possible in examples arranged in accordance with the architectures of FIG. 5A and FIG. 5B. For applications where simultaneous dual-channel operation is not used, the architecture of FIG. 5C may provide improved performance through reduced insertion loss while still using frequency selective backscatter modulation in multiple predetermined channels which may reduce spectrum pollution in some examples.

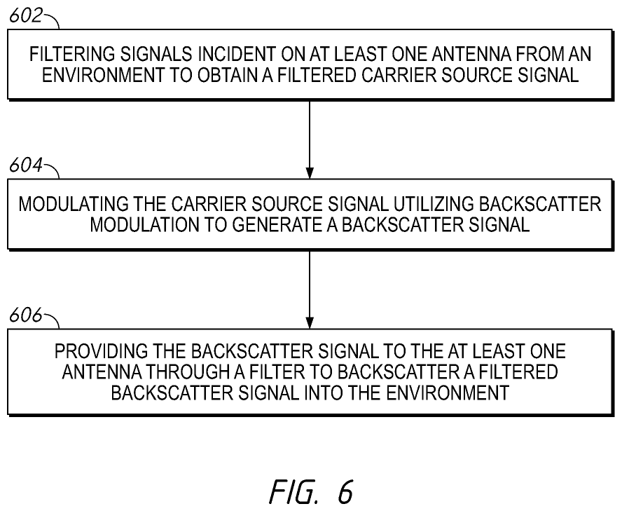

FIG. 6 is a flow chart illustrating a method for backscattering, arranged in accordance with examples described herein. The method includes block 602 which recites filtering signals incident on at least one antenna from an environment to obtain a filtered carrier source signal. Block 602 may be followed by block 604, which recites modulating the carrier source signal utilizing backscatter modulation to generate a backscatter signal. Block 604 may be followed by block 606, which recites providing the backscatter signal to the at least one antenna through a filter to backscatter a filtered backscatter signal into the environment.

The method of FIG. 6 may be performed by devices described herein, such as the devices described with respect to FIG. 1, FIG. 2, FIG. 3, FIG. 5A, FIG. 5B, or FIG. 5C.

The example in FIG. 6 is exemplary. Additional, fewer, and/or different blocks may be provided in other examples, and the blocks may be performed wholly or partially simultaneously in some examples.

Block 602 recites filtering signals incident on at least one antenna from an environment to obtain a filtered carrier source signal. Block 602 may include receiving incident radio frequency signals at an antenna from an environment and filtering the incident signals to obtain a filtered carrier source signal. The incident signals may include energy across a frequency range within the bandwidth of the antenna, which may be a wider or different range than the passband of filters described herein. The filtering may pass frequencies within a passband of a filter while attenuating frequencies outside the passband. The passband of the filter may correspond to a desired frequency band, a single desired channel, or a subset of desired channels. In some examples, the passband may correspond to a particular Bluetooth channel, such as Bluetooth channel 37 (2.401-2.403 GHz), Bluetooth channel 38 (2.425-2.427 GHz), or Bluetooth channel 39 (2.478-2.480 GHz). In other examples, the passband may correspond to a particular Wi-Fi channel, such as Wi-Fi channel 1 (2401-2423 MHz), Wi-Fi channel 6 (2426-2448 MHz), or Wi-Fi channel 11 (2451-2473 MHz). The filter may include an inductor-capacitor filter, a microstrip filter, a low-temperature cofired ceramic (LTCC) filter, a surface acoustic wave (SAW) filter, or a bulk acoustic wave (BAW) filter.

In examples where the method of FIG. 6 is performed by the apparatus of FIG. 1, antenna 101 receives the incident signals and filter 102 performs the filtering to obtain the filtered carrier source signal. In examples where the method of FIG. 6 is performed by the apparatus of FIG. 2, antenna 201 receives the incident signals and filter 205 performs the filtering when RF switch 202 couples antenna 201 to filter 205. In examples where the method of FIG. 6 is performed by the apparatus of FIG. 3, antenna 301 receives the incident signals and filter 305 performs the filtering when RF switch 302 couples antenna 301 to filter 305. In examples where the method of FIG. 6 is performed by the apparatus of FIG. 5A, antenna 516 receives the incident signals and one or both of filter 502 and filter 504 perform the filtering after power splitter 514 divides the incident signals between the two channel paths. In examples where the method of FIG. 6 is performed by the apparatus of FIG. 5B, antenna 548 receives the incident signals and one or both of filter 534 and filter 536 perform the filtering after quadrature hybrid coupler 546 divides the incident signals between the two channel paths. In examples where the method of FIG. 6 is performed by the apparatus of FIG. 5C, antenna 566 receives the incident signals and one of filter 552 or filter 554 performs the filtering based on the position of switch 564 coupling antenna 566 to the selected channel path.

Block 602 may be followed by block 604, which recites modulating the carrier source signal utilizing backscatter modulation to generate a backscatter signal. Block 604 may include using a backscatter modulator to modulate the filtered carrier source signal obtained from the filtering operation of block 602. The backscatter modulator may switch between two or more impedance states in accordance with transmit data to create a time-varying reflection coefficient. In a binary modulation scheme, the backscatter modulator switches between a first impedance and a second impedance. The switching may be controlled by control signals generated by logic circuitry based on the transmit data. As the backscatter modulator switches between impedance states, the time-varying reflection coefficient modulates the filtered carrier source signal to generate a backscatter signal.

In examples where the method of FIG. 6 is performed by the apparatus of FIG. 1, backscatter modulator 103 may perform the modulation under control of logic 107. In examples where the method of FIG. 6 is performed by the apparatus of FIG. 2, backscatter modulator 206 may perform the modulation under control of logic 207. In examples where the method of FIG. 6 is performed by the apparatus of FIG. 3, backscatter modulator 306 may perform the modulation under control of logic 308. In examples where the method of FIG. 6 is performed by the apparatus of FIG. 5A, one or both of switch 506 with impedances 510 and switch 508 with impedances 512 may perform the modulation based on respective transmit data. In examples where the method of FIG. 6 is performed by the apparatus of FIG. 5B, one or both of switch 538 with impedances 542 and switch 540 with impedances 544 may perform the modulation based on respective transmit data. In examples where the method of FIG. 6 is performed by the apparatus of FIG. 5C, either switch 556 with impedances 560 or switch 558 with impedances 562 may perform the modulation based on which channel path is selected by switch 564.

Block 604 may be followed by block 606, which recites providing the backscatter signal to the at least one antenna through a filter to backscatter a filtered backscatter signal into the environment. Block 606 may include routing the backscatter signal generated by the backscatter modulator through a filter and providing the filtered backscatter signal to an antenna for re-radiation into the environment. The filter may perform a second filtering operation on the backscatter signal, passing frequencies within the passband of the filter while attenuating frequencies outside the passband. This second filtering operation may reduce spectrum pollution by preventing or reducing the re-radiation of modulation sidebands outside the desired frequency band or channel. The filtered backscatter signal may be provided to the antenna, which re-radiates the signal into the environment where it can be received by other devices. The filter used for filtering the backscatter signal may be the same filter used for filtering the incident signals in block 602.

In examples where the method of FIG. 6 is performed by the apparatus of FIG. 1, filter 102 filters the backscatter signal from backscatter modulator 103 and provides the filtered backscatter signal to antenna 101 for re-radiation. In examples where the method of FIG. 6 is performed by the apparatus of FIG. 2, filter 205 filters the backscatter signal from backscatter modulator 206 and provides the filtered backscatter signal through RF switch 202 to antenna 201 for re-radiation. In examples where the method of FIG. 6 is performed by the apparatus of FIG. 3, filter 305 filters the backscatter signal from backscatter modulator 306 and provides the filtered backscatter signal through RF switch 302 to antenna 301 for re-radiation. In examples where the method of FIG. 6 is performed by the apparatus of FIG. 5A, one or both of filter 502 and filter 504 filter respective backscatter signals and provide the filtered signals to power splitter 514, which combines them for re-radiation by antenna 516. In examples where the method of FIG. 6 is performed by the apparatus of FIG. 5B, one or both of filter 534 and filter 536 filter respective backscatter signals and provide the filtered signals to quadrature hybrid coupler 546, which combines them for re-radiation by antenna 548. In examples where the method of FIG. 6 is performed by the apparatus of FIG. 5C, either filter 552 or filter 554 filters the backscatter signal and provides the filtered signal through switch 564 to antenna 566 for re-radiation.

During operation, the method of FIG. 6 may allow frequency selective backscatter communication by filtering both incident signals and backscattered signals to pass frequencies within a desired passband while attenuating frequencies outside the passband. The dual filtering operations may reduce spectrum pollution by preventing the modulation of incident signals outside the desired frequency band and by preventing the re-radiation of modulation sidebands outside the desired frequency band. Examples of the method may allow a backscatter device to communicate in a specific Bluetooth channel, Wi-Fi, or cellular channel while avoiding interference with other wireless communication systems operating in nearby frequency bands. The method may be performed continuously during periods when backscatter communication is used in some examples, with logic circuitry controlling the backscatter modulator to switch impedances in accordance with transmit data to be communicated. In examples where multiple channel paths are available, such as in the examples of FIG. 5A, FIG. 5B, or FIG. 5C, the method may include selecting which channel path to use. The channel path determination may be based on available carrier power in each channel, data transmission requirements, or other factors.

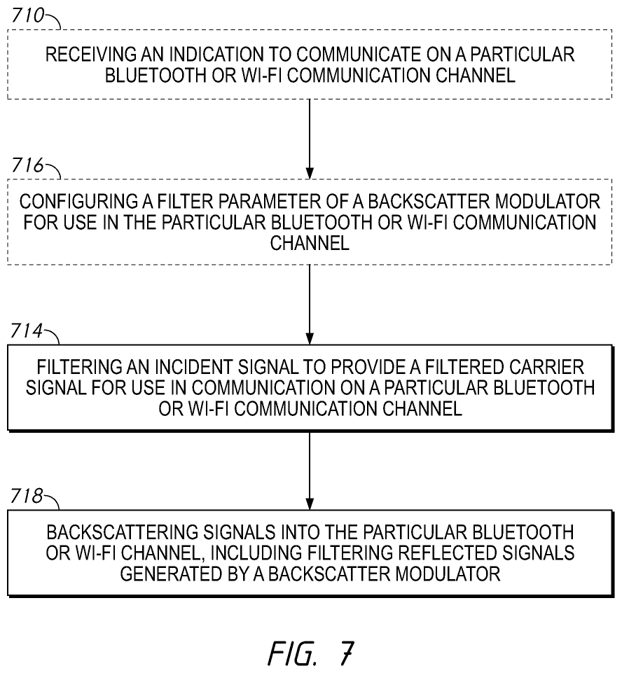

FIG. 7 is a flow chart illustrating a method for communicating on a particular Bluetooth, Wi-Fi, and/or cellular communication channel, arranged in accordance with examples described herein. The method includes block 710, which recites receiving an indication to communicate on a particular Bluetooth, Wi-Fi, or cellular communication channel. Block 710 may be followed by block 716, which recites configuring a filter parameter of a backscatter modulator for use in the particular Bluetooth, Wi-Fi, or cellular communication channel. Block 716 may be followed by block 714, which recites filtering an incident signal to provide a filtered carrier signal for use in communication on a particular Bluetooth, Wi-Fi, or cellular communication channel. Block 714 may be followed by block 718 which recites backscattering signals into the particular Bluetooth, Wi-Fi, or cellular channel, including filtering reflected signals generated by a backscatter modulator. The method of FIG. 7 may be performed by devices described herein, such as those described with respect to FIG. 1, FIG. 2, FIG. 3, FIG. 5A, FIG. 5B, or FIG. 5C.

The example in FIG. 7 is exemplary. Additional, fewer, and/or different blocks may be provided in other examples. The blocks may be performed wholly or partially simultaneously in some examples. The blocks may occur in other orders in other examples. The block 710 and block 716 may be optional in some examples.

Block 710 recites receiving an indication to communicate on a particular Bluetooth or Wi-Fi communication channel. Block 710 may include receiving a signal, command, or instruction specifying that communication should occur on a designated Bluetooth channel or Wi-Fi channel. The indication may be received through a receiver, such as receiver 104 in FIG. 1, receiver 307 in FIG. 3, or through another interface coupled to logic circuitry described herein. The indication may include data identifying the particular channel, such as a channel number corresponding to Bluetooth channel 37 (2.401-2.403 GHz), Bluetooth channel 38 (2.425-2.427 GHz), Bluetooth channel 39 (2.478-2.480 GHz), Wi-Fi channel 1 (2401-2423 MHz), Wi-Fi channel 6 (2426-2448 MHz), or Wi-Fi channel 11 (2451-2473 MHz). The indication may originate from an external device such as a smartphone, tablet, access point, or base station that transmits commands to the backscatter apparatus. In some examples, the indication may be received as part of a downlink transmission that precedes an uplink backscatter communication session. The indication may be encoded within a packet header, control field, or dedicated signaling channel according to the applicable wireless protocol. Logic circuitry, such as logic 107 in FIG. 1, logic 207 in FIG. 2, or logic 308 in FIG. 3, may receive and/or process the indication to determine which channel has been specified for communication.

Block 710 may be followed by block 716, which recites configuring a filter parameter of a backscatter modulator for use in the particular Bluetooth or Wi-Fi communication channel. Block 716 may include adjusting characteristics of a filter to select its passband for the particular channel specified in the indication received in block 710. In examples where a tunable filter is provided, such as described with respect to filter 102 in FIG. 1, block 716 may include adjusting the tunable filter to set its passband center frequency and bandwidth to match the particular channel. The filter parameter may include center frequency, bandwidth, stopband attenuation, passband ripple, and/or other frequency response characteristics. In examples where the filter includes switches such as field effect transistors (FETs) or PIN diodes to adjust passband frequencies, configuring the filter parameter may include providing control voltages or currents to the switches to select appropriate circuit configurations. In examples where the filter includes voltage controlled elements such as varactors, configuring the filter parameter includes providing control voltages to the varactors to adjust capacitance values and thereby shift the passband frequencies. The filter parameter configuration may be controlled by logic circuitry described herein that may generate appropriate control signals based on the channel identifier from the indication. In examples where the filter has a fixed passband that already matches the particular channel, block 716 may include verifying that the filter passband corresponds to the particular channel without making adjustments. In examples using apparatus with multiple fixed filters for different channels, such as FIG. 5A, FIG. 5B, or FIG. 5C, block 716 may involve selecting an appropriate channel path having a filter with a passband corresponding to the particular channel.

In examples where the method of FIG. 7 is performed by the apparatus of FIG. 5A, configuring the filter parameter in block 716 may include selecting between filter 502 and filter 504 based on whether the particular channel matches the first predetermined channel or the second predetermined channel. Logic circuitry may analyze the channel identifier from the indication received in block 710 and determine which filter has a passband corresponding to the particular channel. If the particular channel matches the first predetermined channel, the logic circuitry may activate the first channel path including filter 502, switch 506, and impedances 510. If the particular channel matches the second predetermined channel, the logic circuitry may activate the second channel path including filter 504, switch 508, and impedances 512. In examples where the method of FIG. 7 is performed by the apparatus of FIG. 5B, configuring the filter parameter in block 716 may include selecting between filter 534 and filter 536 in an analogous manner, with the logic circuitry activating the appropriate channel path through quadrature hybrid coupler 546. In examples where the method of FIG. 7 is performed by the apparatus of FIG. 5C, configuring the filter parameter in block 716 may include controlling switch 564 to couple antenna 566 to either the first channel path including filter 552 or the second channel path including filter 554, based on which filter has a passband corresponding to the particular channel.

Block 716 may be followed by block 714, which recites filtering an incident signal to provide a filtered carrier signal for use in communication on a particular Bluetooth or Wi-Fi communication channel. Block 714 includes passing incident signals received at an antenna through a filter having a passband corresponding to the particular channel. The incident signal includes radio frequency energy present in the environment that can serve as a carrier source for backscatter modulation. The incident signal may originate from access points, base stations, smartphones, or other wireless devices operating in the frequency bands encompassing the particular channel. The incident signal may be some other signal available in the environment. The filter may receive the incident signal and filters it to pass frequencies within the passband while attenuating frequencies outside the passband. Examples of filters described herein may perform the filtering of block 714, such as filter 102 of FIG. 1, filter 205 of FIG. 2, and/or filter 305 of FIG. 3. In examples of multi-channel devices described herein, one or more filters may perform the filtering of block 714. For example, a filter selected in block 716 may perform the filtering operation in block 714.

Block 714 may be followed by block 718, which recites backscattering signals into the particular Bluetooth or Wi-Fi channel, including filtering reflected signals generated by a backscatter modulator. Block 718 may include passing backscatter signals generated by the backscatter modulator through the filter and providing the filtered backscatter signals to an antenna for re-radiation into the environment. The backscatter modulator may switch between impedance states in accordance with transmit data, creating a time-varying reflection coefficient that modulates the filtered carrier signal. The modulated backscatter signals are provided back to the filter. The filter may perform a filtering operation on the backscatter signals, passing frequencies within the passband of the particular channel while attenuating frequencies outside the passband. This filtering operation of the modulated backscatter signals may remove modulation sidebands and/or harmonic components that fall outside the particular channel, preventing or reducing these out-of-channel components from being re-radiated by the antenna. The filtering may aid in providing frequency selectivity to the backscatter operation by confining the backscattered energy to within the particular channel.

The backscattering of block 718 may be provided by devices described herein, such as the devices of FIG. 1, FIG. 2, FIG. 3, FIG. 4, or FIGS. 5A-5C.

Accordingly, during operation, examples of the method of FIG. 7 may provide channel-specific backscatter communication by optionally receiving an indication specifying a particular Bluetooth or Wi-Fi channel, optionally configuring filter parameters to match the particular channel, filtering incident signals to obtain a filtered carrier signal within the particular channel, and filtering backscatter signals to confine backscattered energy to the particular channel. The method may be performed by apparatus having a single channel path with a tunable filter, such as FIG. 1, FIG. 2, or FIG. 3, where the filter parameter configuration in block 716 adjusts the tunable filter passband to match the particular channel. The method may also be performed by apparatus having multiple channel paths with fixed filters for different predetermined channels, such as FIG. 5A, FIG. 5B, or FIG. 5C, where the filter parameter configuration in block 716 involves selecting the appropriate channel path having a filter with a passband corresponding to the particular channel. The method may allow dynamic channel selection based on external indications, allowing the backscatter apparatus to adapt to changing channel conditions or to follow channel assignments from coordinating devices.

From the foregoing it will be appreciated that, although specific embodiments have been described herein for purposes of illustration, various modifications may be made while remaining with the scope of the claimed technology. Any of the communication channels referred to herein may include Bluetooth, WiFi, or cellular communication channels.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. A method comprising:
filtering an incident signal on to a backscatter modulator to provide a filtered carrier signal for use in communication on a particular Bluetooth or Wi-Fi communication channel; and
backscattering signals into the particular Bluetooth or Wi-Fi communication channel including filtering reflected signals generated by the backscatter modulator, the filtering specific to the particular Bluetooth or Wi-Fi communication channel.

2. The method of claim 1, wherein the particular Bluetooth or Wi-Fi channel is a Bluetooth advertising channel.

3. The method of claim 1, wherein the particular Bluetooth or Wi-Fi channel is a channel in accordance with the IEEE 802.11 standard.

4. The method of claim 1, further comprising:
receiving an indication to communicate on the particular Bluetooth or Wi-Fi communication channel; and
configuring a filter parameter for said filtering for use in the particular Bluetooth or Wi-Fi communication channel.

5. An apparatus comprising:
at least one antenna configured to receive an incident signal;
a backscatter modulator configured to switch between impedances in accordance with transmit data to provide a switched impedance; and
a filter coupled to the backscatter modulator to filter the incident signal to provide a filtered incident signal to the backscatter modulator and to filter the reflected signal from the switched impedance to provide a filtered reflected signal to the at least one antenna.

6. The apparatus of claim 5, wherein the backscatter modulator is a first backscatter modulator and the filter is a first filter, the apparatus further comprising:
a second backscatter modulator configured to switch between a second set of selected impedances in accordance with second transmit data to provide a second switched output signal;
a second filter coupled to the second backscatter modulator to filter the second switched output signal to a second predetermined channel and couple the second filtered switched output signal to the antenna.

7. The apparatus of claim 5, wherein the selected impedances are provided by a transistor.

8. The apparatus of claim 5, wherein a reflection coefficient is created at the at least one antenna based, at least in part, on the filter.

9. The apparatus of claim 5, further comprising a coupler.

10. The apparatus of claim 5, further comprising a quadrature hybrid coupler.

11. The apparatus of claim 5, wherein the filter comprises a tunable filter.

12. The apparatus of claim 6, wherein the first predetermined channel is a first Bluetooth channel and wherein the second predetermined channel is a second Bluetooth channel, different from the first Bluetooth channel.

13. The apparatus of claim 6, wherein the first predetermined channel is a first Wi-Fi channel and wherein the second predetermined channel is a second Wi-Fi channel, different from the first Wi-Fi channel.

14. The apparatus of claim 5, further comprising an energy harvester coupled to the backscatter modulator.

15. A method comprising:
filtering signals incident on at least one antenna from an environment to obtain a filtered carrier source signal;
modulating the carrier source signal utilizing backscatter modulation to generate a backscatter signal;
providing the backscatter signal to the at least one antenna through a filter to backscatter a filtered backscatter signal into the environment.

16. The method of claim 15, wherein the filter is configured to exclude frequencies from a particular carrier band.

17. The method of claim 15, wherein the filter is configured to increase the backscattered power within a particular carrier band.

18. The method of claim 15, wherein the filtered carrier source signal is in a first frequency range, the method further comprising:
filtering the signals incident on the at least one antenna to obtain a second filtered carrier source signal in a second frequency range different than the first frequency range;
modulating the second carrier source signal utilizing backscatter modulation to generate a second backscattered signal; and
providing the second backscatter signal to the at least one antenna through a second filter to backscatter a second filtered backscatter signal into the environment.

19. The method of claim 18, wherein the first frequency range is associated with a first Bluetooth channel and the second frequency range is associated with a second Bluetooth channel.

20. The method of claim 18, wherein the first frequency range is associated with a first Wi-Fi channel and the second frequency range is associated with a second Wi-Fi channel.
